(19) United States
(12) Patent Application Publication
(10) Pub. No.: US 2025/0382775 A1
(43) Pub. Date: Dec. 18, 2025

(54) COCKPIT WARNING AND IDENTIFICATION SYSTEM

(71) Applicant: CHIMEI MOTOR ELECTRONICS CO., LTD., TAINAN CITY (TW)

(72) Inventors: Hsueh-Hsien HSU, TAINAN CITY (TW); Cheng-Chian WANG, TAINAN CITY (TW); Kai-Quan ZHONG, TAINAN CITY (TW)

(21) Appl. No.: 18/746,036

(22) Filed: Jun. 18, 2024

(51) Int. Cl. E02F 9/26; G06F 3/04886; G06V 10/80; G06V 20/56

(52) U.S. Cl. CPC E02F 9/26; G06F 3/04886; G06V 10/80; G06V 20/56

(57) ABSTRACT

A cockpit warning and identification system includes plural cameras, a processor, and a display device. The cameras are mounted on a construction vehicle and configured to capture surrounding images of the construction vehicle. The processor is disposed in the cockpit of the construction vehicle and is in signal connection with the cameras. The processor is configured to receive the surrounding images, combine the surrounding images into an around view image of the construction vehicle, and perform image recognition processing on the around view image to obtain a risk status of the construction vehicle. The display device is mounted in the cockpit and is in signal connection with the processor. The display device is configured to receive and display the around view image. The processor controls the display device to display a corresponding picture on the around view image according to the risk status of the construction vehicle.

### BACKGROUND

### Field of Invention

The present disclosure relates to a vehicle warning technology, and more particularly, to a cockpit warning and identification system.

### Description of Related Art

Construction vehicles such as excavators and bulldozers should be equipped with warning devices such as reversing or rotating warning lights and buzzers to warn people around the construction vehicles to prevent hitting them during operation. However, such warning devices can only be used to warn people around the construction vehicles, and cannot provide the operators with more complete information about the surrounding risky objects, such that the operators cannot effectively grasp changes in the working environment, such as people who suddenly enter the working radius of the construction vehicles.

Therefore, there is a need for a warning system for construction vehicles to provide operators with more complete working environment information.

### SUMMARY

One objective of the present disclosure is to provide a cockpit warning and identification system, a processor of which can receive surrounding images captured by plural cameras, combine the surrounding images into an around view image of the construction vehicle, and perform image recognition processing on the around view image to identify whether there are risky objects in the around view image, and moving speeds and directions of the risky objects, so as to obtain a risk status of the construction vehicle to display on the display device in the cockpit. Therefore, the cockpit warning and identification system can provide an operator in the cockpit with more complete information about surrounding risky objects, such that the operator can effectively grasp changes in the operating environment, thereby significantly reducing operational risks.

According to the aforementioned objectives, the present disclosure provides a cockpit warning and identification system. The cockpit warning and identification system includes plural cameras, a processor, and a display device. The cameras are mounted on a construction vehicle, in which each of the cameras is configured to capture a surrounding image of the construction vehicle. The processor is disposed in a cockpit of the construction vehicle and is in signal connection with the cameras. The processor is configured to receive the surrounding images, combine the surrounding images into an around view image of the construction vehicle, and perform image recognition processing on the around view image to obtain a risk status of the construction vehicle. The display device is mounted in the cockpit and is in signal connection with the processor. The display device is configured to receive and display the around view image. The processor controls the display device to display a corresponding picture on the around view image according to the risk status of the construction vehicle.

According to one embodiment of the present disclosure, a number of the cameras is 4, and a shooting range of each of the cameras is 190 degrees.

According to one embodiment of the present disclosure, the processor is disposed in the display device, and the display device has a touch screen.

According to one embodiment of the present disclosure, the around view image contains an image of the construction vehicle. The processor is further configured to divide the around view image into a plurality of areas, and the areas surround the image of the construction vehicle. The corresponding picture includes plural sub-pictures respectively corresponding to the areas. The processor individually controls the sub-pictures.

According to one embodiment of the present disclosure, each of the sub-pictures includes plural warning patterns, and the sub-pictures are arranged from a side of the image of the construction vehicle in a direction away from the image.

According to one embodiment of the present disclosure, in each of the sub-pictures, the warning patterns have different colors.

According to one embodiment of the present disclosure, when the risk status of the construction vehicle is that at least one risky object appears in one of the areas of the around view image, the processor controls the display device to display the corresponding sub-picture on the one of the areas. When the risk status of the construction vehicle is that the at least one risky object has not existed in the one of the areas in the around view image, the processor controls the display device to turn off the corresponding sub-picture of the one of the areas.

According to one embodiment of the present disclosure, when the at least one risky object enters the one of the areas and moves towards the image, the processor controls the display device to display the corresponding sub-picture on the one of the areas by displaying the warning patterns of the sub-picture one by one with 100% brightness as the at least one risky object approaches, and turning off the warning patterns in a gradually fading manner within a predetermined time after the at least one risky object is away. A corresponding one of the warning patterns where the at least one risky object resides is displayed with a transparency of 50%.

According to one embodiment of the present disclosure, when the at least one risky object enters the one of the areas and moves toward the image at a speed greater than a predetermined speed, the processor controls the display device to display the corresponding sub-picture on the one of the areas by repeating twice of displaying the warning patterns of the sub-picture one by one with 100% brightness as the at least one risky object approaches, and turning off the warning patterns in the gradually fading manner after the at least one risky object is away.

According to one embodiment of the present disclosure, the cockpit warning and identification system further includes a buzzer mounted on the construction vehicle, in which the buzzer is in signal connection with the processor. The processor is further configured to control the buzzer to go off a warning sound when the risk status of the construction vehicle is that at least one risky object appears in the around view image.

According to one embodiment of the present disclosure, the cockpit warning and identification system further includes a warning light mounted on the construction vehicle, in which the warning light is in signal connection with the processor. The processor is further configured to control the warning light to emit warning light when the risk status of the construction vehicle is that at least one risky object appears in the around view image.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 is a block diagram of a cockpit warning and identification system in accordance with an embodiment of the present disclosure.

FIG. 2 is a schematic diagram of a construction vehicle in accordance with an embodiment of the present disclosure.

FIG. 3 is a schematic diagram of an around view image of a construction vehicle in accordance with an embodiment of the present disclosure.

FIG. 4 is a schematic diagram of displaying warning patterns of a sub-picture of a corresponding picture, which corresponds to a risk status of a construction vehicle in accordance with an embodiment of the present disclosure.

FIG. 5 is a schematic diagram of displaying warning patterns of a sub-picture of a corresponding picture, which corresponds to another risk status of a construction vehicle in accordance with an embodiment of the present disclosure.

FIG. 6 is a block diagram of a cockpit warning and identification system in accordance with another embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms “first”, “second”, and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Moreover, the terms “connected”, “electrically connected”, or the like between two components referred to in the present disclosure are not limited to the direct connection or electrical connection of the two components, and may also include indirect connection or electrical connection as required.

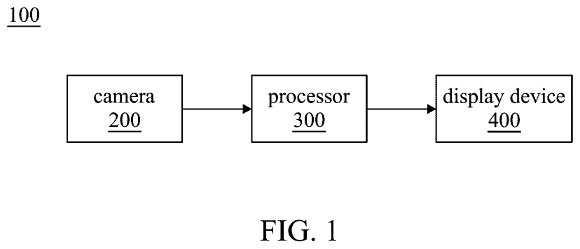

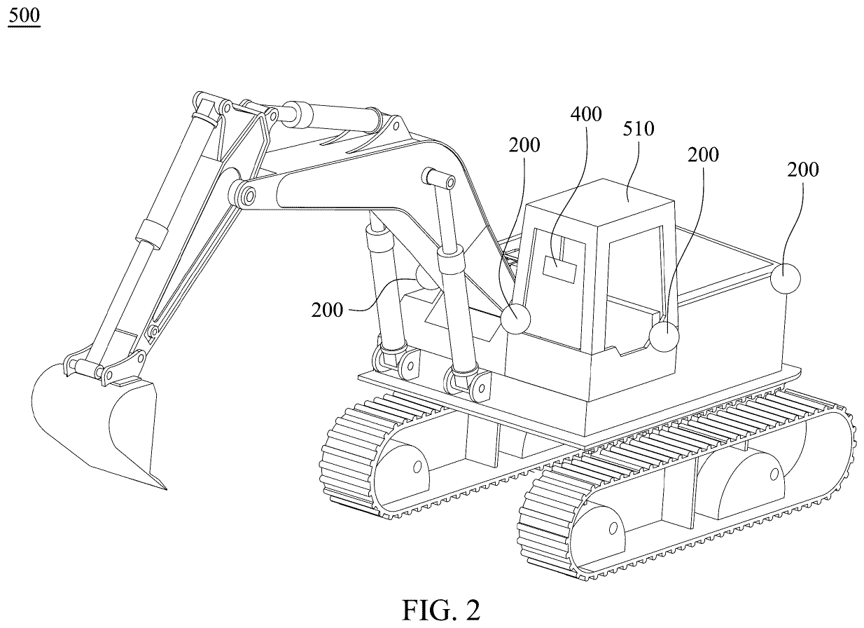

Referring to FIG. 1 and FIG. 2, FIG. 1 and FIG. 2 respectively illustrate a block diagram of a cockpit warning and identification system 100 and a schematic diagram of a construction vehicle 500 in accordance with an embodiment of the present disclosure. The cockpit warning and identification system 100 is applied to the construction vehicle 500 to provide an operator in the cockpit 510 of the construction vehicle 500 with more complete risk information to enhance the safety of the construction vehicles 500 during operation. For example, the construction vehicle 500 may be an excavator, a bulldozer, a forklift truck, etc.

The cockpit warning and identification system 100 may mainly include plural cameras 200, processor 300, and display device 400. The cameras 200 are mounted on the construction vehicle 500. For example, the cameras 200 may be mounted on a front side, a rear side, a left side, and a right side of the cockpit 510 of the construction vehicle 500 to capture surrounding images of the construction vehicle 500 from the four sides of the construction vehicle 500. In some examples, a number of the cameras 200 is 4, and a shooting range of each of the cameras 200 is 190 degrees. Thus, the shooting ranges of the cameras 200 can completely cover the surroundings of the construction vehicle 500. The number and the shooting range of the cameras 200 are not limited to the aforementioned examples, as long as the shooting ranges of all the cameras 200 can completely cover the surroundings of the construction vehicle 500.

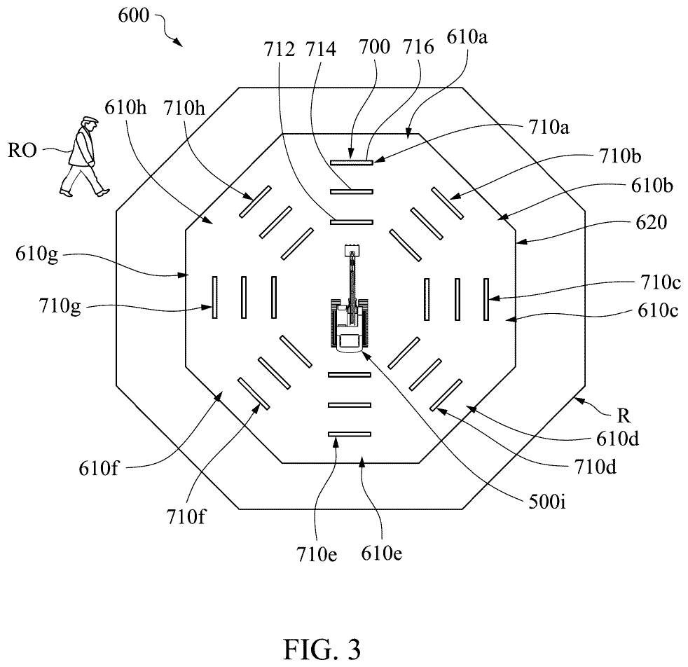

The processor 300 is disposed in the cockpit 510 of the construction vehicle 500. The processor 300 may be in signal connection with the cameras 200 through a wired transmission method or a wireless transmission method. Thus, the processor 300 can receive the surrounding images of the construction vehicle 500 captured by the cameras 200. Referring to FIG. 3, FIG. 3 is a schematic diagram of an around view image 600 of a construction vehicle 500 in accordance with an embodiment of the present disclosure. The processor 300 can stitch the received surrounding images through an image processing method to form the around view image 600 of the construction vehicle 500. In the example shown in FIG. 3, the around view image 600 is an octagonal image. The around view image 600 may be an image of other shapes, such as a square, a circle, a polygon other than a square, etc., and the present disclosure is not limited thereto. The around view image 600 may include an image 500i of the construction vehicle 500. In some examples, the processor 300 can divide the around view image 600 into plural areas 610a to 610h, in which the areas 610a to 610h surround the image 500i of the construction vehicle 500. The around view image 600 is not limited to eight areas 610a to 610h. The around view image 600 can be divided according to using requirements, and the present disclosure is not limited thereto.

The processor 300 can further perform image recognition processing on the around view image 600 to identify whether there is a risky object RO in the around view image 600, a moving speed of the risky object RO, and a distance between the risky object RO and the image 500i of the construction vehicle 500 so as to obtain a risk status of the construction vehicle 500. For example, the processor 300 may calculate the moving speed of the risky object RO by using the moving distance of the risky object RO between two pictures and the display time of each of the pictures. In addition, the processor 300 can directly identify the distance between the risky object RO and the image 500i of the construction vehicle 500 in the around view image 600 to obtain the distance between the risky object RO and the construction vehicle 500.

In some examples, the processor 300 is in signal connection with a control system of the cockpit 510 of the construction vehicle 500 through a wired method or a wireless method, and can receive operation information of the construction vehicle 500. For example, the processor 300 may obtain the rotation information, the movement information, and the machine tool operation information of the construction vehicle 500 from the control system of the cockpit 510. The machine tool operation information may be, for example, information of an excavation operation of the excavator, information of a bulldozing operation and a shoveling operation of the bulldozer, and information of the lifting and lowering of forks of the forklift truck. The risk status of the construction vehicle 500 when rotating, moving, and/or operating is higher than that when the construction vehicle 500 is stationary, such that the processor 300 can further determine the risk status of the construction vehicle 500 based on the operation information of the construction vehicle 500 to reduce the operation risk of the construction vehicle 500.

The processor 300 can predict whether the risky object RO will enter the working range of the construction vehicle 500 and the time when the risky object RO will enter the working range of the construction vehicle 500 based on the moving speed and the direction of the risky object RO. When the processor 300 makes the above prediction, the processor 300 may further base on the operation information of the construction vehicle 500.

The display device 400 is mounted in the cockpit 510 of the construction vehicle 500, and can be in signal connection with the processor 300 through a wired transmission method or a wireless transmission method. In some examples, the processor 300 may be disposed in the display device 400 and be electrically connected to the display device 400 through physical wires. The display device 400 can receive the around view image 600 from the processor 300 and display the around view image 600. In some examples, as shown in FIG. 3, the around view image 600 includes a display area 620, and a range R of the around view image 600 formed by the surrounding images captured by the cameras 200 is larger than the display area 620. That is, the detection range of the cameras 200 is larger than the range displayed by the display device 400. Thus, the processor 300 can identify the risky object RO when the risky object RO enters the range R of the around view image 600 but has not entered the display area 620.

The processor 300 can further control the display device 400 to display a corresponding picture 700 on the around view image 600 according to the risk status of the construction vehicle 500 obtained through the image recognition processing. The corresponding picture 700 may include plural sub-pictures, such as sub-pictures 710a to 710h. In the example shown in FIG. 3, the around view image 600 is divided into eight areas 610a to 610h, and the corresponding picture 700 is divided into eight sub-pictures 710a to 710h, which are displayed corresponding to the areas 610a to 610h respectively. That is, the number of sub-pictures 710a to 710h is equal to the number of the areas 610a to 610h. The processor 300 can individually control the sub-pictures 710a to 710h. For example, when the risky object RO enters the area 610h of the around view image 600, the processor 300 controls the display device 400 to display the sub-picture 710h of the corresponding picture 700 on the area 610h.

In some examples, each of the sub-pictures 710a to 710h includes plural warning patterns, such as warning patterns 712, 714, and 716. The warning patterns 712, 714, and 716 may be on-screen displays (OSD). The number of the warning patterns in each of the sub-pictures 710a to 710h can be adjusted according to needs and is not limited to three. As shown in FIG. 3, the warning patterns 712, 714, and 716 are arranged from a side of the image 500i of the construction vehicle 500 in a direction away from the image 500i. Specifically, the warning pattern 712 is closest to the image 500i of the construction vehicle 500, the warning pattern 716 is farthest from the image 500i, and the warning pattern 714 is located between the warning patterns 712 and 716. In some examples, the warning patterns 712, 714, and 716 have different colors to facilitate the operator to visually identify the degree of risk. For example, the warning pattern 712 may be red, the warning pattern 714 may be orange, and the warning pattern 716 may be green.

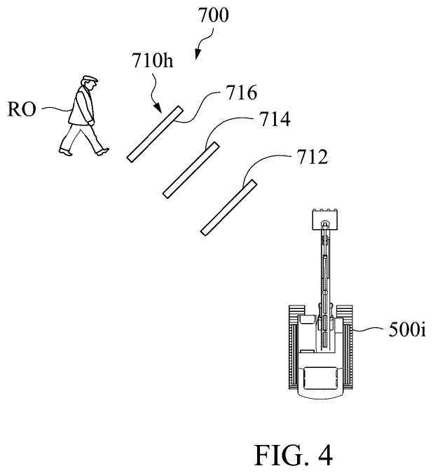

Referring to FIG. 3 and FIG. 4 simultaneously, FIG. 4 is a schematic diagram of displaying warning patterns 712, 714, and 716 of a sub-picture 710h of a corresponding picture 700, which corresponds to a risk status of a construction vehicle 500 in accordance with an embodiment of the present disclosure. When the risk status of the construction vehicle 500 obtained by the processor 300 is that at least one risky object RO appears in one of the areas 610a to 610h of the around view image 600, the processor 300 controls the display device 400 to display the corresponding one of the sub-pictures 710a to 710h on the one of the areas 610a to 610h. For example, when the risk status of the construction vehicle 500 is that the risky object RO appears in the area 610h of the around view image 600, the processor 300 controls the display device 400 to display the sub-picture 710h on the area 610h. In some examples, when the risky object RO enters the area 610h and moves towards the image 500i of the construction vehicle 500, the processor 300 controls the display device 400 to display the corresponding sub-picture 710h on the area 610h by displaying the warning patterns 716, 714, and 712 of the sub-picture 710h one by one with 100% brightness, that is the brightness from 0% directly to 100%, as the risky object RO approaches. The warning patterns 716, 714, and 712 gradually fade out by reducing the brightness from 100% to 50% within a predetermined time, such as 5 seconds, after the risky object RO is far away.

Specifically, when the risky object RO enters the area 610h, the risky object RO first approaches the position corresponding to the warning pattern 716, the processor 300 controls the display device 400 to display the warning pattern 716 in the sub-picture 710h with 100% brightness on the area 610h. When the risky object RO continues to move towards the image 500i of the construction vehicle 500 to the position corresponding to the warning pattern 714, the processor 300 controls the display device 400 to display the warning pattern 714 in the sub-picture 710h with 100% brightness, and to gradually fade the brightness of the warning pattern 716 from 100% to 50% within a predetermined time. The risky object RO continues to move to the position corresponding to the warning pattern 712, the processor 300 controls the display device 400 to display the warning pattern 712 in the sub-picture 710h with 100% brightness, and to gradually fade the brightness of the warning pattern 714 from 100% to 50% within the predetermined time, or gradually fade away. If the risky object RO finally resides at the warning pattern 712, the warning pattern 712 is displayed with a transparency of, for example, 50%.

When the risk status of the construction vehicle 500 is that there is no risky object RO in the one of the areas 610a to 610h of the around view image 600, the processor 300 controls the display device 400 to turn off the one of the sub-pictures 710a to 710h corresponding to the one of the areas 610a to 610h. For example, when there is no risky object RO in the area 610h, the processor 300 controls the display device 400 to turn off the corresponding sub-picture 710h.

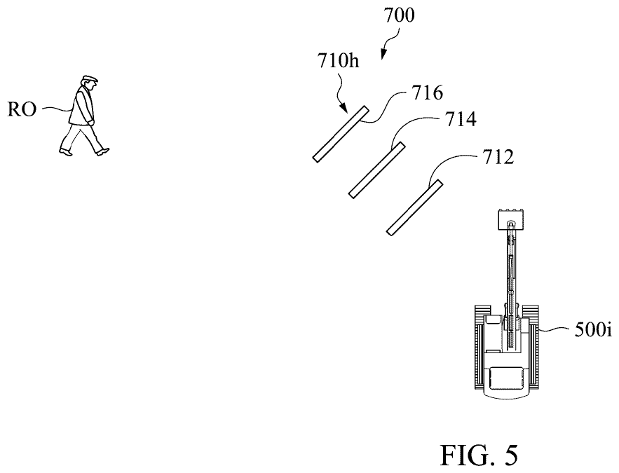

Referring to FIG. 3 and FIG. 5 simultaneously, FIG. 5 is a schematic diagram of displaying warning patterns 712, 714, and 716 of a sub-picture 710h of a corresponding picture 700, which corresponds to another risk status of a construction vehicle 500 in accordance with an embodiment of the present disclosure. When the risky object RO enters one of the areas 610a to 610h, such as the area 610h, and moves rapidly toward the image 500i of the construction vehicle 500 at a speed greater than a predetermined speed, the processor 300 controls the display device 400 to display the corresponding sub-picture 710h on the area 610h. The processor 300 controls the warning patterns 716, 714, and 712 of the sub-picture 710h to be displayed one by one with 100% brightness as the risky object RO approaches, and controls the warning patterns 716, 714, and 712 to gradually fade out from 100% to 50% in brightness, or gradually fade away and turn off after the risky object RO is far away, which are repeated twice in sequence. The warning pattern 712, 714, or 716 corresponding to the place where the risky object RO resides is displayed with a transparency of, for example, 50%. Therefore, the cockpit warning and identification system 100 can provide different warnings according to the moving conditions of the risky object RO.

A screen of the display device 400 may be a touch screen. Therefore, the screen of the display device 400 can be used as a human-machine operation interface to facilitate the driver to set the image recognition processing settings of the processor 300 and the display settings of the display device 400, etc.

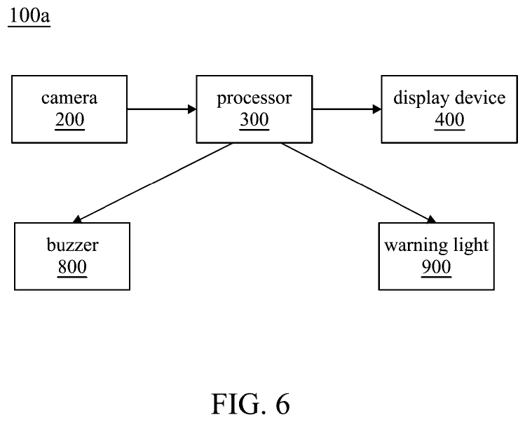

Referring to FIG. 6, FIG. 6 is a block diagram of a cockpit warning and identification system 100a in accordance with another embodiment of the present disclosure. The structure of the cockpit warning and identification system 100a of the present embodiment is similar to the aforementioned cockpit warning and identification system 100. The difference between the cockpit warning and identification systems 100a and 100 is that the cockpit warning and identification system 100a further includes a buzzer 800 and a warning light 900.

Referring to FIG. 2 and FIG. 3 together, the buzzer 800 is mounted on the construction vehicle 500 and may be in signal connection with the processor 300 via a wired transmission method or a wireless transmission method. In some examples, the buzzer 800 is located outside the display device 400 and may be electrically connected to the display device 400 using a wire. The buzzer 800 may be electrically connected to a circuit system in the cockpit 510 of the construction vehicle 500. When the processor 300 recognizes that the risk status of the construction vehicle 500 is that the risky object RO appears in any of the areas 610a to 610h of the around view image 600, the processor 300 can control the buzzer 800 to go off a warning sound to remind the operator.

The warning light 900 is mounted on the construction vehicle 500 and may be in signal connection with the processor 300 via a wired transmission method or a wireless transmission method. In some examples, the warning light 900 may be outside the display device 400 and connected to the display device 400 via a wire. When the processor 300 recognizes that the risk status of the construction vehicle 500 is that the risky object RO appears in any of the areas 610a to 610h of the around view image 600, the processor 300 can control the warning light 900 to emit warning light to alert the operator.

In some examples, when the construction vehicle 500 is inactive, it may only use the display device 400 to display the around view image 600 and the corresponding picture 700. However, when the construction vehicle 500 is inactive, in addition to displaying the around view image 600 and the corresponding picture 700, the buzzer 800 and the warning light 900 may also be used for warning. When the construction vehicle 500 moves, rotates, and/or operates, in addition to using the display device 400 to display the around view image 600 and the corresponding picture 700, it is preferably to use the buzzer 800 and the warning light 900 to provide warnings.

According to the embodiments described above, one advantage of the present disclosure is that the processor of the cockpit warning and identification system can receive surrounding images captured by plural cameras, combine the surrounding images into an around view image of the construction vehicle, and perform image recognition processing on the around view image to identify whether there are risky objects in the around view image, and moving speeds and directions of the risky objects, so as to obtain a risk status of the construction vehicle to display on the display device in the cockpit. Therefore, the cockpit warning and identification system can provide an operator in the cockpit with more complete information about surrounding risky objects, such that the operator can effectively grasp changes in the operating environment, thereby significantly reducing operational risks.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. A cockpit warning and identification system, comprising:
a plurality of cameras mounted on a construction vehicle, wherein each of the cameras is configured to capture a surrounding image of the construction vehicle;
a processor disposed in a cockpit of the construction vehicle and in signal connection with the cameras, wherein the processor is configured to receive the surrounding images, combine the surrounding images into an around view image of the construction vehicle, and perform image recognition processing on the around view image to obtain a risk status of the construction vehicle; and
a display device mounted in the cockpit and in signal connection with the processor, wherein the display device is configured to receive and display the around view image, and the processor controls the display device to display a corresponding picture on the around view image according to the risk status of the construction vehicle.

2. The cockpit warning and identification system of claim 1, wherein a number of the cameras is 4, and a shooting range of each of the cameras is 190 degrees.

3. The cockpit warning and identification system of claim 1, wherein the processor is disposed in the display device, and the display device has a touch screen.

4. The cockpit warning and identification system of claim 1, wherein the around view image contains an image of the construction vehicle, the processor is further configured to divide the around view image into a plurality of areas, the areas surround the image of the construction vehicle, the corresponding picture comprises a plurality of sub-pictures respectively corresponding to the areas, and the processor individually controls the sub-pictures.

5. The cockpit warning and identification system of claim 4, wherein each of the sub-pictures comprises a plurality of warning patterns, and the sub-pictures are arranged from a side of the image of the construction vehicle in a direction away from the image.

6. The cockpit warning and identification system of claim 5, wherein in each of the sub-pictures, the warning patterns have different colors.

7. The cockpit warning and identification system of claim 5, wherein
when the risk status of the construction vehicle is that at least one risky object appears in one of the areas of the around view image, the processor controls the display device to display the corresponding sub-picture on the one of the areas; and
when the risk status of the construction vehicle is that the at least one risky object has not existed in the one of the areas in the around view image, the processor controls the display device to turn off the corresponding sub-picture of the one of the areas.

8. The cockpit warning and identification system of claim 7, wherein when the at least one risky object enters the one of the areas and moves towards the image, the processor controls the display device to display the corresponding sub-picture on the one of the areas by displaying the warning patterns of the sub-picture one by one with 100% brightness as the at least one risky object approaches, and turning off the warning patterns in a gradually fading manner within a predetermined time after the at least one risky object is away, and a corresponding one of the warning patterns where the at least one risky object resides is displayed with a transparency of 50%.

9. The cockpit warning and identification system of claim 8, wherein when the at least one risky object enters the one of the areas and moves toward the image at a speed greater than a predetermined speed, the processor controls the display device to display the corresponding sub-picture on the one of the areas by repeating twice of displaying the warning patterns of the sub-picture one by one with 100% brightness as the at least one risky object approaches, and turning off the warning patterns in the gradually fading manner after the at least one risky object is away.

10. The cockpit warning and identification system of claim 1, further comprising a buzzer mounted on the construction vehicle, wherein the buzzer is in signal connection with the processor, and the processor is further configured to control the buzzer to go off a warning sound when the risk status of the construction vehicle is that at least one risky object appears in the around view image.

11. The cockpit warning and identification system of claim 1, further comprising a warning light mounted on the construction vehicle, wherein the warning light is in signal connection with the processor, and the processor is further configured to control the warning light to emit warning light when the risk status of the construction vehicle is that at least one risky object appears in the around view image.
